(19) United States
(12) Patent Application Publication
(10) Pub. No.: US 2012/0073370 A1
(43) Pub. Date: Mar. 29, 2012

(54) MICROMECHANICAL STRUCTURE

(76) Inventors: Dietrich Schubert, Reutlingen (DE); Wolfgang Fuerst, Reutlingen (DE); Stefan Liebing, Kiebingen (DE); Stefan Rurlaender, Reutlingen (DE)

(21) Appl. No.: 13/259,392

(22) PCT Filed: Jan. 20, 2010
(86) PCT No.: PCT/EP2010/050634

§ 371 Date: Dec. 8, 2011

(30) Foreign Application Priority Data
May 26, 2009 (DE) 10 2009 026 476.0

(51) Int. Cl. G01C 19/56

(52) U.S. Cl. 73/504.12

(57) ABSTRACT

A micromechanical structure, in particular an acceleration sensor, is described, having a substrate, a seismic mass, which is movable relative to the substrate, and at least one anchoring element, which is fixedly connected to the substrate, the seismic mass being attached to the substrate by the anchoring element, and at least one spring element being situated between the seismic mass and the anchoring element, and furthermore, the anchoring element has at least one stop element for interaction with at least one counterstop element of the seismic mass.

### FIELD OF THE INVENTION

The present invention is directed to a micromechanical structure.

### BACKGROUND INFORMATION

German Patent Application No. DE 198 17 357 A1 describes an acceleration sensor having a substrate, a spring element and a seismic mass. The spring element is connected to the substrate at a first end and to the seismic mass at a second end, so that movement of the mass relative to the substrate may be induced by acceleration of the acceleration sensor parallel to a surface of the substrate. For the spring element, a spring stop is provided, limiting the deformation of the spring element during acceleration parallel to the surface of the substrate. The spring stop must be fixedly connected to the substrate. A similar acceleration sensor is described in German Patent Application No. DE 100 38 761 A1, which also has stops to limit the deflection of the seismic mass, the stops being designed as part of the spring element.

### SUMMARY

The example micromechanical structures according to the present invention have the advantage that a deflection of the seismic mass relative to the substrate is effectively limited by the interaction of the stop element and the counterstop element, without necessitating a separate substrate connection for the stop element and without the spring properties of the spring element being influenced by the stop element. By eliminating the separate substrate connection and the possible use of standard spring elements, a much more compact design and less expensive manufacturing of the micromechanical structure according to the present invention are made possible. This is achieved by designing the stop element as part of the anchoring element, while the complementary counterstop element is designed as part of the seismic mass. The anchoring element at the same time is advantageously used for fastening the seismic mass and also for fastening the stop element on the substrate. The spring elements are used to ensure the mobility of the seismic mass with respect to the substrate and also with respect to the anchoring element. The maximum deflection of the seismic mass with respect to the substrate is limited by a mechanical contact between the stop element and the counterstop element. Due to the connection between the seismic mass and the anchoring element in the form of the spring element, the stop element and the counterstop element are at the same electrical potential in particular, so that a force action and in particular an adhesion between the stop element and the counterstop element are reliably ruled out due to electrostatic interactions. Integration of the stop element into the anchoring element also has the advantage that a comparatively compact integration of the stop element is achieved, so that the manufacturing costs are reduced due to the savings of wafer area. Furthermore, the manufacture of the micromechanical structure is simplified because the stop element does not require separate substrate anchoring. Another advantage is that the stop element is not situated in the area of the spring element, i.e., is not part of the spring element, because in this case the spring properties are greatly altered, in particular with regard to wanted and unwanted vibration modes, and thus new spring geometries would be required. With the example micromechanical structure according to the present invention, the design of the spring element remains unaffected by the stop element, so that the micromechanical structure is to be equipped with conventional and proven spring geometries. The anchoring element includes in particular not just one area connected directly to the substrate perpendicularly to the substrate but also a connecting area between this area, which is connected directly to the substrate and is perpendicular to the substrate, and the spring element, so that this connecting area is designed to be free-standing and underetched.

According to one preferred refinement, it is provided that the stop element and the counterstop element are situated opposite one another along and/or perpendicular to a sensing direction in the micromechanical structure. Thus, a maximal deflection of the micromechanical structure with respect to the substrate is limited along the sensing direction in an advantageous manner. In an acceleration sensor, the sensing direction corresponds to the direction along which an acceleration is measured, for example. Due to the limitation on the maximal deflection, damage to the micromechanical structure due to excessive acceleration forces is suppressed in particular, and excessive acceleration forces, for example, a breakaway of the spring elements or the development of a mechanical or electrostatic adhesion between the fixed electrodes and the counterelectrodes after mechanical contact between the fixed electrodes and the counterelectrodes may be induced, so that the seismic mass is unable to return to its zero position. Alternatively or additionally, a maximal deflection of the seismic mass perpendicular to the sensing direction is implementable with the aid of a stop element and a counterstop element which are situated opposite one another and perpendicular to the sensing direction, whereby the effects of mechanical and/or electrostatic external forces on the acceleration sensor, for example, are reduced.

According to another preferred refinement, it is provided that the stop element is designed as a dent of the anchoring element and/or the counterstop element is designed as a dent of the seismic mass. The stop element and the counterstop element are advantageously implemented in a comparatively simple and compact manner. In one preferred specific embodiment, the stop element and/or the counterstop element has/have a nonstick coating, which suppresses adhesion of the stop element and the counterstop element.

According to another preferred refinement, it is provided that the stop element and/or the counterstop element is/are designed to be partially elastic and preferably L-shaped. Kinetic energy of the seismic mass is advantageously converted into deformation energy shortly before reaching the maximal deflection of the seismic mass, and thus the seismic mass is decelerated before reaching the maximal deflection. The mechanical forces acting on the micromechanical structure on reaching the maximal deflection are therefore reduced.

According to another preferred refinement, it is provided that the anchoring element is situated in a central area of the micromechanical structure. A comparatively compact design of the micromechanical structure is thus made possible in an advantageous manner. In addition, a mirror symmetrical design of the micromechanical structure with respect to the plane of symmetry is implemented, the plane of symmetry being perpendicular to the substrate plane on the one hand and running parallel or perpendicular to the sensing direction on the other hand, and the measurement accuracy of the micromechanical structure being increased on the whole by such a mirror symmetrical design.

According to another preferred refinement, it is provided that the micromechanical structure has fixed electrodes for cooperating with counterelectrodes of the seismic mass, the fixed electrodes and the counterelectrodes preferably being designed as comb electrodes, which intermesh perpendicularly to the sensing direction. The sensing direction runs parallel to the substrate plane in particular. During acceleration of the acceleration sensor along the sensing direction, the seismic mass moves antiparallel to the acceleration in relation to the substrate due to inertia forces. This results in a change in distance between the fixed electrodes and the counterelectrodes parallel to the sensing direction, thereby inducing a measurable change in the electrical capacitance between the fixed electrodes and the counterelectrodes, providing a measure for the acceleration.

Another subject matter of the present invention is a micromechanical structure, in particular an acceleration sensor having a substrate, a seismic mass movable relative to the substrate and at least one anchoring element fixedly connected to the substrate, the seismic mass being attached to the substrate by the anchoring element and at least one spring element being situated between the seismic mass and the anchoring element, the micromechanical structure having fixed electrodes for interacting with counterelectrodes of the seismic mass, the seismic mass having at least one additional stop element and at least one additional counterstop element and the additional counterstop element being fixedly connected to a fixed electrode. Thus, the additional counterstop element is advantageously fixedly connected to the fixed electrode structure, which is attached to the substrate in particular by an additional anchoring element. By connecting the additional counterstop element to the fixed electrode structure, no additional substrate connection is required for fastening the additional counterstop element, thus permitting a much simpler, less expensive and more compact design of the micromechanical structure.

According to one preferred refinement, it is provided that the additional stop element and/or the additional counterstop element is/are preferably designed to be elastic and in particular preferably L-shaped, so that a more cautious deceleration of the seismic mass before reaching maximal deflection is achieved in an advantageous manner.

According to another preferred refinement, it is provided that the additional counterstop element includes a fixed electrode and/or an additional anchoring element, the additional anchoring element preferably being provided for fastening the fixed electrodes to the substrate, so that the counterstop element advantageously does not require any separate substrate connection.

According to another preferred refinement, it is provided that the additional stop element extends generally parallel to the fixed electrodes and the counterelectrodes and is situated between at least one fixed electrode and the additional anchoring element along the sensing direction in particular. The additional counterstop element in this case is automatically formed by the fixed electrodes and/or the additional anchoring element in an advantageous manner, so that no additional structures are required for the implementation of the additional counterstop element.

Exemplary embodiments of the present invention are depicted in the figures and explained in greater detail.

### BRIEF DESCRIPTION OF THE DRAWINGS

FIG. 1 shows a schematic top view of a conventional micromechanical structure.

FIGS. 2a and 2b show a schematic top view and a schematic detailed view of a micromechanical structure according to a first specific embodiment of the present invention.

FIG. 2c shows a schematic detailed view of a micromechanical structure according to a second specific embodiment of the present invention.

FIGS. 3a and 3b show a schematic top view and a schematic detailed view of a micromechanical structure according to a third specific embodiment of the present invention.

FIG. 3c shows a schematic detailed view of a micromechanical structure according to a fourth specific embodiment of the present invention.

FIG. 4 shows a schematic top view of a micromechanical structure according to a fifth specific embodiment of the present invention.

FIGS. 5a and 5b show a schematic top view and a schematic detailed view of a micromechanical structure according to a sixth specific embodiment of the present invention.

FIGS. 6a and 6b show a schematic top view and a schematic detailed view of a micromechanical structure according to a seventh specific embodiment of the present invention.

### DETAILED DESCRIPTION OF EXAMPLE EMBODIMENTS

In the various figures, the same parts are always labeled with the same reference numerals and therefore are usually mentioned only once.

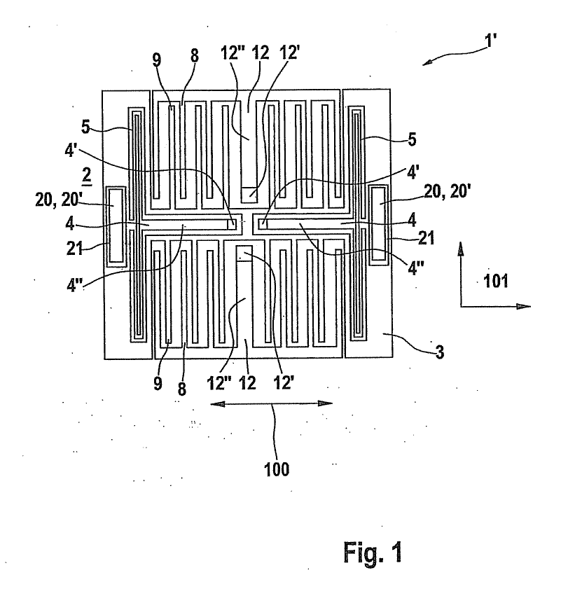

FIG. 1 shows a schematic top view of a micromechanical structure 1′ in the form of an acceleration sensor according to the related art, where micromechanical structure 1′ has a substrate 2 and a seismic mass 3 connected to substrate 2 by two anchoring elements 4. Spring elements 5 are situated between corresponding anchoring element 4 and seismic mass 3, so that seismic mass 3 is designed to be movable with respect to substrate 2 along a sensing direction 100 parallel to substrate plane 101. Furthermore, micromechanical structure 1′ has fixed electrodes 8 fixedly connected to substrate 2, provided for interacting with complementary counterelectrodes 9 of seismic mass 3. Fixed electrodes 8 are connected to substrate 2 via an additional anchoring element 12. Fixed electrodes 8 and counterelectrodes 9 are designed as intermeshing comb electrodes, the fingers of the comb electrodes being spaced a distance apart and overlapping one another in sensing direction 100. During acceleration of the acceleration sensor along sensing direction 100, seismic mass 3 moves antiparallel to the acceleration direction in relation to substrate 2 due to inertia forces. This results in a change in distance between fixed electrodes 8 and counterelectrodes 9 parallel to sensing direction 100, thereby inducing a measurable change in the electrical capacitance between fixed electrodes 8 and counterelectrodes 9, which thus provides a measure for the acceleration. To limit the deflection of seismic mass 3 with respect to substrate 2 perpendicular and parallel to sensing direction 100, micromechanical structure 1′ includes two stop units 20, each including an additional anchoring element 20′ for anchoring on substrate 2 and each being situated in a recess 21 in seismic mass 3. The deflection of seismic mass 3 is limited by a mechanical contact between stop unit 20 and the edge of seismic mass 3 in the area of recess 21. The conventional micromechanical structure 1′ therefore requires an enlarged seismic mass 3 for providing recesses 21 and also requires two additional anchoring elements 20′.

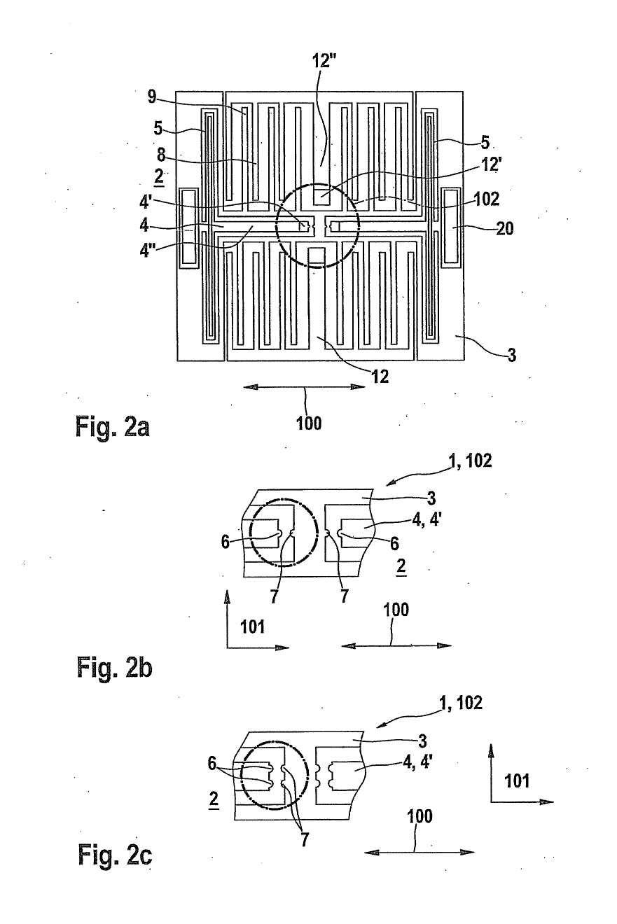

FIG. 2a shows a schematic top view of a micromechanical structure 1 according to a first specific embodiment of the present invention, which corresponds generally to the conventional micromechanical structure shown in FIG. 1, micromechanical structure 1 according to the first specific embodiment of the present invention also having two stop elements 6, each designed as part of one of two anchoring elements 4. These stop elements 6 are designed as dents in the respective anchoring element 4. Each stop element 6 cooperates with a complementary counterstop element 7 of seismic mass 3, which is designed opposite stop element 6 along sensing direction 100, thus limiting the deflection of seismic mass 3 in relation to substrate 2 and parallel to sensing direction 100. Counterstop elements 7 are therefore designed as complementary dents in seismic mass 3. FIG. 2b shows an enlarged partial view 102 of micromechanical structure 1 according to the first specific embodiment of the present invention, as illustrated in FIG. 2a. FIG. 2c shows a schematic detailed view of a micromechanical structure 1 according to a second specific embodiment of the present invention, which is generally identical to the first specific embodiment illustrated in FIG. 2b, each of two anchoring elements 4 having two stop elements 6, each cooperating with two complementary counterstop elements 7 of seismic mass 3. Micromechanical structure 1 in the sense of the present invention is alternatively also implementable using any other plurality of stop and counterstop elements 6, 7.

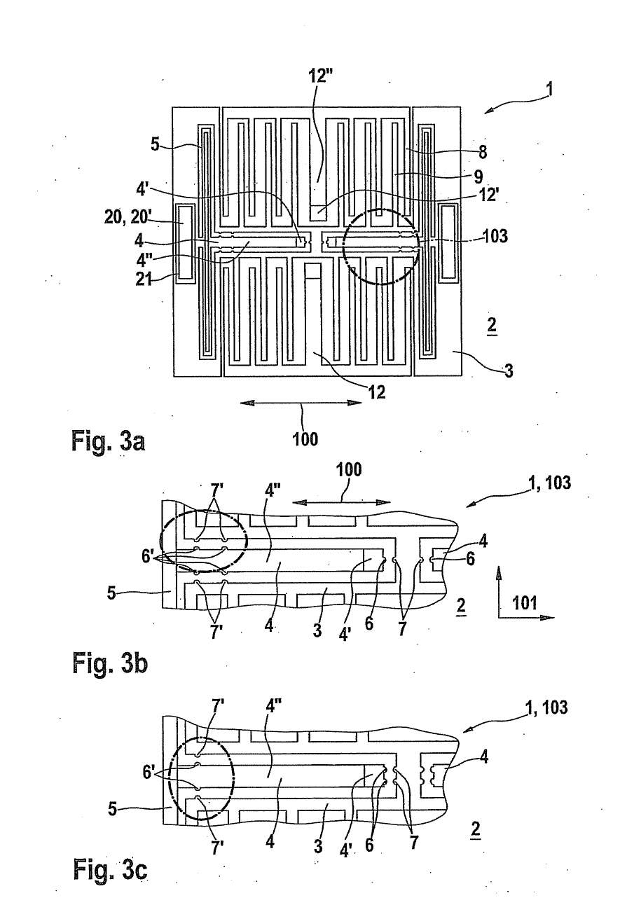

FIGS. 3a and 3b show a schematic top view and a schematic detailed view 103 of a micromechanical structure 1 according to a third specific embodiment of the present invention, the third specific embodiment being generally identical to the first specific embodiment illustrated in FIGS. 2a and 2b, anchoring elements 4 having stop elements 6′ in addition to opposing stop elements 6 with counterstop elements 7 along sensing direction 100, these additional stop elements being situated perpendicular to sensing direction 100 opposite additional complementary counterstop elements 7′ of seismic mass 3, so that the deflection of seismic mass 3 relative to substrate 2 is also limited perpendicularly to sensing direction 100. FIG. 3c shows a schematic detailed view 103 of a micromechanical structure 1 according to a fourth specific embodiment of the present invention, which is essentially identical to the third specific embodiment illustrated in FIG. 3b, only the number of stop elements and counterstop elements 6, 7, 6′, 7′ being different.

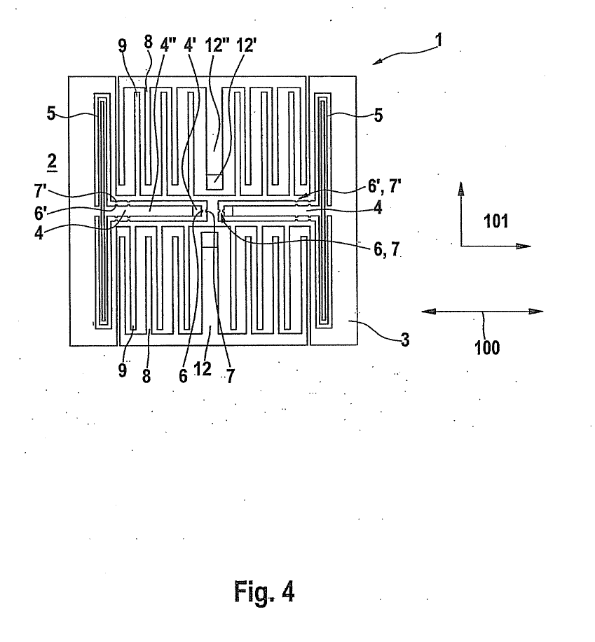

FIG. 4 shows a schematic top view of a micromechanical structure 1 according to a fifth specific embodiment of the present invention, the fifth specific embodiment being generally identical to the first, second, third or fourth specific embodiment, micromechanical structure 1 according to the fifth specific embodiment not having any stop units 20, because in this case the maximal deflection of seismic mass 3 relative to substrate 2 parallel and/or perpendicular to sensing direction 100 is limited by the plurality of cooperating stop and counterstop elements 6, 7, 6′, 7′. By saving stop units 20, no additional anchoring elements 20′ and no recesses 21 are needed, so that micromechanical structure 1 is designed without any change in functionality but with a definitely more compact design on the whole.

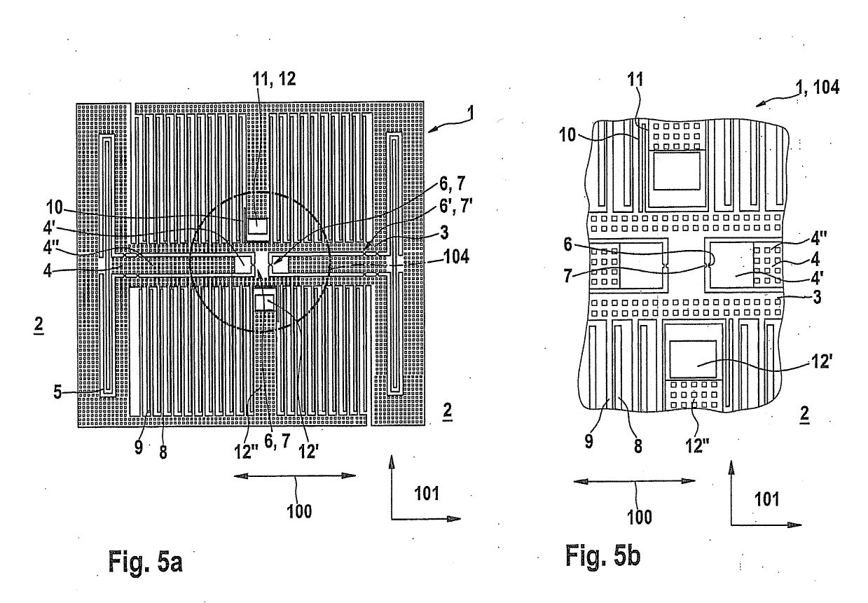

FIGS. 5a and 5b show a schematic top view and a schematic detailed view 104 of a micromechanical structure 1 according to a sixth specific embodiment of the present invention, the sixth specific embodiment corresponding generally to the fourth specific embodiment shown in FIG. 3c, where seismic mass 3 has two additional stop elements 10, which cooperate with two additional counterstop elements 11. Counterstop elements 11 are designed as part of additional anchoring elements 12, which fasten fixed electrodes 8 on substrate 2 and include in particular an additional dent 11′ on additional anchoring elements 12. Additional stop elements 10 include an elastic L shape extending from seismic mass 3 perpendicular to sensing direction 100 and parallel to fixed and counterelectrodes 8, 9. A movement of seismic mass 3 along sensing direction 100 is decelerated before reaching the maximal deflection, i.e., in particular before the development of a mechanical contact between stop and counterstop elements 6, 7 which are opposite and parallel to sensing direction 100 by additional stop and counterstop elements 10, 11. Anchoring elements 4 are situated in a central area of micromechanical structure 1 in particular, comb electrode structures and in particular exactly one pair of additional stop and counterstop elements 10, 11 being situated on each side of anchoring elements 4.

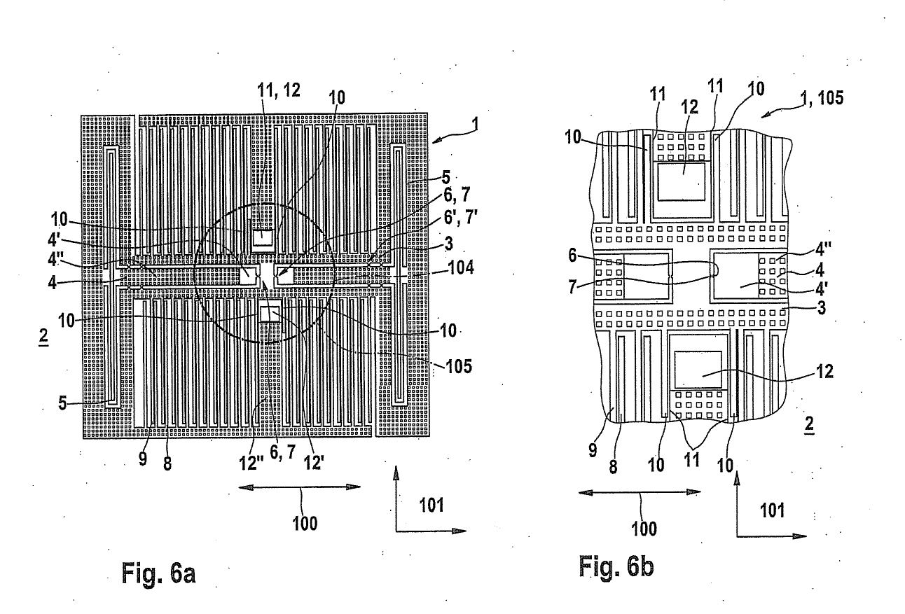

FIGS. 6a and 6b show a schematic top view and a schematic detailed view 105 of a micromechanical structure 1 according to a seventh specific embodiment of the present invention, the seventh specific embodiment corresponding generally to the sixth specific embodiment illustrated in FIGS. 5a and 5b, two pairs of additional stop and counterstop elements 10, 11 being situated on each side of anchoring elements 4. Stop and counterstop elements 10, 11 are thus situated in mirror symmetry opposite a plane of symmetry running perpendicular to the substrate plane and centrally along the respective additional anchoring element 12, so that no torque is exerted on seismic mass 3 by additional stop and counterstop elements 10, 11 before reaching the maximal deflection during deceleration of seismic mass 3.

1-10. (canceled)

11. A micromechanical structure comprising:
a substrate;
a seismic mass movable relative to the substrate;
at least one anchoring element fixedly connected to the substrate, the seismic mass being attached to the substrate by the anchoring element; and
at least one spring element situated between the seismic mass and the anchoring element;
wherein the anchoring element has at least one stop element for cooperating with at least one counterstop element of the seismic mass.

12. The micromechanical structure as recited in claim 11, wherein the stop element and the counterstop element are situated opposite each other one of along and perpendicular to a sensing direction.

13. The micromechanical structure as recited in claim 11, wherein at least one of the stop element is designed as a dent of the anchoring element, and the counterstop element is designed as a dent of the seismic mass.

14. The micromechanical structure as recited in claim 11, wherein at least one of the stop element and the counterstop element is partially elastic and L-shaped.

15. The micromechanical structure as recited in claim 11, wherein the anchoring element is situated in a central area of the micromechanical structure.

16. The micromechanical structure as recited in claim 11, wherein the micromechanical structure has fixed electrodes for cooperating with counterelectrodes of the seismic mass, the fixed electrodes and the counterelectrodes being comb electrodes which intermesh perpendicularly to a sensing direction.

17. The micromechanical structure as recited in claim 11, wherein the micromechanical structure has fixed electrodes for cooperating with counterelectrodes of the seismic mass, the seismic mass having at least one additional stop element and at least one additional counterstop element, the additional counterstop element being fixedly connected to a fixed electrode.

18. The micromechanical structure as recited in claim 17, wherein at least one of the additional stop element and the additional counterstop element is elastic and L-shaped.

19. The micromechanical structure as recited in claim 17, wherein the additional counterstop element includes at least one of a fixed electrode and an additional anchoring element, the additional anchoring element for fastening fixed electrodes on the substrate.

20. The micromechanical structure as recited in claim 17, wherein the additional stop element extends generally parallel to the fixed electrodes and the counterelectrodes, and is situated along the sensing direction between at least one fixed electrode and the additional anchoring element.
